(19) United States
(12) Patent Application Publication
(10) Pub. No.: US 2002/0074939 A1
(43) Pub. Date: Jun. 20, 2002

(54) Charged particle beam apparatus

(75) Inventor: Yukiharu Okubo, Kawasaki-shi (JP)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/789,553

(22) Filed: Feb. 22, 2001

(30) Foreign Application Priority Data
Feb. 24, 2000 (JP) JP 2000-047571

(51) Int. Cl. H01J 31/50

(52) U.S. Cl. 313/525

(57) ABSTRACT

The object of the present invention is to provide a charged particle beam apparatus which can inspect axial offset and cross-sectional states of charged particle beams accurately and easily. For achieving such an object, the charged particle beam apparatus in accordance with the present invention comprises charged particle beam outputting means for outputting a charged particle beam; a lens barrel through which the charged particle beam passes; a mark member having a light-emitting material on a surface on a side irradiated with the charged particle beam, and an opening, the light-emitting material emitting light upon irradiation with the charged particle beam; and viewing means for viewing the light-emitting material of the mark member.

### BACKGROUND OF THE INVENTION

1. Field of the Invention

The present invention relates to a charged particle beam apparatus for inspecting axial offset and cross-sectional states of charged particle beams such as electron beams and ion beams when they pass through a lens barrel.

2. Related Background Art

Various apparatus using electron beams such as electron microscopes and electron beam exposure apparatus have conventionally been known. For axial alignment of electron beams passing through a lens barrel, these apparatus inspect the axial offset of electron beams by using a metal member provided with a hole through which electrons pass. Usually, the metal member is arranged such that the center of the through hole aligns with a reference axis of the lens barrel.

If a metal member is irradiated with an electron beam, current (beam current) flows through the metal member. The amount of beam current is substantially in proportion to the area of metal member irradiated with the electron beam. For example, when the state where the whole cross section of an electron beam 61 irradiates a metal member 62 as shown in FIG. 10A and the state where a part of the cross section of electron beam 61 irradiates the metal member 62 while another part reaches a through hole 63 as shown in FIG. 10B are compared with each other, the amount of beam current is greater in the former than in the later as the irradiation area is greater.

A conventional axial offset inspection using the metal member 62 is carried out while the electron beam 61 is scanned one-dimensionally or two-dimensionally so as to travel across the through hole 63. As the electron beam 61 is scanned, the area of metal member 62 irradiated with the electron beam 61 changes, whereby the amount of beam current flowing through the metal member 62 changes. If the change in amount of beam current is detected so as to determine the scan timing of electron beam 61 (amount of deflection caused by the deflector) at which the amount of beam current is the lowest, then the axial offset of electron beam 61 can be inspected.

The axial offset is adjusted according to the result of axial offset inspection, whereby the electron beam 61 is axially aligned with a reference axis 64 of a lens barrel. The reference axis 64 of lens barrel corresponds to the optical axis of an electronic optical system such as an electron lens or deflector arranged within the lens barrel.

### SUMMARY OF THE INVENTION

In the conventional axial offset inspection, however, the axial offset of electron beam 61 cannot be detected unless the amount of beam current changes upon scanning the electron beam 61. The state where the amount of beam current does not change often occurs at initial stages of starting apparatus. This state occurs mainly because of the fact that the electron beam 61 greatly deviates from the reference axis 64 or the cross section of electron beam 61 is wider than the through hole 63.

If the electron beam 61 deviates greatly from the reference axis 64, then it will not travel across the through hole 63 even when scanned within a predetermined range, whereby the amount of beam current will stay constant. If the cross section of electron beam 61 is wider than the through hole 63, on the other hand, then the area of through hole 63 included within the cross section will not change even when the electron beam 61 is scanned, whereby the amount of beam current will remain constant.

If the amount of beam current is constant as such, then it can be seen from the amount of current that the electron beam 61 irradiates somewhere in the metal member 62, but it cannot be seen how much and in which direction the irradiating electron beam 61 shifts from the through hole 63 of metal member 62. Also, it cannot be seen whether the reason why the amount of beam current does not change is because of the fact that the axial offset of electron beam 61 is large or its cross section is wider.

Therefore, the conventional axial offset inspection necessitates a cumbersome operation in which, while conditions for an electron lens or deflector arranged upstream the metal member 62 are changed by trial and error, axial offset and cross-sectional states of the electron beam 61 are investigated and set to those in which the amount of beam current changes upon scanning the electron beam 61.

It is an object of the present invention to provide a charged particle beam apparatus which can inspect axial offset and cross-sectional states of charged particle beams accurately and easily.

For achieving such an object, the charged particle beam apparatus in accordance with the present invention comprises charged particle beam outputting means for outputting a charged particle beam; a lens barrel through which the charged particle beam passes; a mark member having a light-emitting material on a surface on a side irradiated with the charged particle beam, and an opening, the light-emitting material emitting light upon irradiation with the charged particle beam; and viewing means for viewing the light-emitting material of the mark member. Since the mark member is arranged within a lens barrel such that a center of the opening formed in the mark member and a reference axis of the lens barrel align with each other, the positional relationship of mark member with respect to the reference axis of lens barrel is made clear.

If the light-emitting material of mark member is irradiated with a charged particle beam in thus configured charged particle beam apparatus, then the light-emitting material at the irradiated part actually emits light. If the part actually emitted light is observed with the viewing means, then it can be verified that the charged particle beam has reached the mark member.

Since the positional relationship between the part where the light-emitting material emits light and the reference axis of lens barrel is clear, the size and form of charged particle beam and the amount and direction of axial offset of charged particle beam with respect to the reference axis of lens barrel can be seen when the form and size of light-emitting part are observed.

The present invention will be more fully understood from the detailed description given hereinbelow and the accompanying drawings, which are given byway of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a schematic view of an electron beam apparatus 10 in accordance with a first embodiment;

FIG. 2 is a top plan view of a mark plate 11;

FIGS. 3A to 3C are views for explaining a light-emitting part 19 of a fluorescent material 17 applied to the mark plate 11;

FIGS. 4A and 4B are top plan and side views of a mark plate 25 of a second embodiment, respectively;

FIG. 5 is a schematic view of an electron beam apparatus 30 in accordance with a third embodiment;

FIG. 6 is a view for explaining one-dimensional high-speed scanning of an electron beam 20;

FIGS. 7A to 7C are views for explaining two-dimensional high-speed scanning, movement by a predetermined amount, and enlargement in cross section of the electron beam 20, respectively;

FIG. 8 is a schematic view of an electron beam apparatus 40 in accordance with a fourth embodiment;

FIG. 9 is a schematic view of an electron beam apparatus 50 in accordance with a fifth embodiment; and

FIGS. 10A and 10B are views for explaining a conventional axial offset inspection.

### DESCRIPTION OF THE PREFERRED EMBODIMENTS

In the following, embodiments of the present invention will be explained in detail with reference to the drawings.

First Embodiment

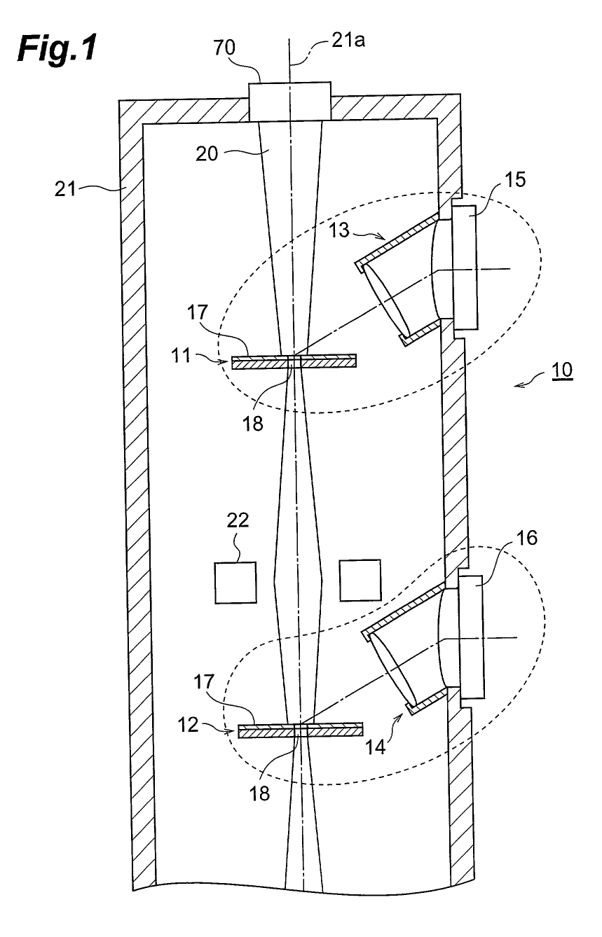

In a first embodiment, an electron beam apparatus will be explained as an example of charged particle beam apparatus. As shown in FIG. 1, the electron beam apparatus 10 in accordance with the first embodiment comprises an electron beam outputting means 70 for outputting an electron beam 20, a lens barrel 21 through which the electron beam 20 passes, and mark plates 11, 12 disposed along a reference axis 21a of the lens barrel 21. Here, the reference axis is a line connecting the electron beam emitting source and an electron beam control device which is necessary in terms of designing an electronic optical system. A vacuum state is established within the lens barrel 21 in order for the electron beam 20 to pass therethrough. The lens barrel 21 is provided with viewing windows 15, 16 for viewing light emitted when the mark plates 11, 12 are irradiated with the electron beam 20. An electron lens 22 is disposed near the mark plate 12 on the side irradiated with the electron beam 20. The electron lens 22 is arranged such that its optical axis aligns with the reference axis 21a of lens barrel 21. The electron lens 22 is an electrostatic or electromagnetic lens and exerts a converging action on the electron beam 20 as with a convex lens in optics.

The electron beam apparatus 10 in accordance with the first embodiment is an apparatus which can view the size and form of the electron beam 20 passing through the electron lens 22 within the lens barrel 21 and its axial offset with respect to the reference axis 21a. Though not depicted, an adjusting device (electron lens, stigmeter, deflector, or the like) for regulating the cross section and axial offset of electron beam 20 is also arranged upstream the electron beam apparatus 10 within the lens barrel 21.

The electron beam apparatus 10 has two mark plates (mark members) 11, 12 arranged within the lens barrel 21 along the reference axis 21a, and two loupes 13, 14 and two viewing windows (viewing means) 15, 16 attached to the lens barrel 21.

In these two sets, one set of mark plate 11, loupe 13, and viewing window 15 are arranged upstream the electron lens 22, whereas the other set of mark plate 12, loupe 14, and viewing window 16 are arranged downstream the electron lens 22.

In the electron beam apparatus 10, the mark plates 11, 12 have configurations identical to each other, the loupes 13, 14 have configurations identical to each other, and the viewing windows 15, 16 have configurations identical to each other. Therefore, while configurations of one set of mark plate 11, loupe 13, and viewing window 15 will be explained in detail, those of the other set of mark plate 12, loupe 14, and viewing window 16 will not be explained.

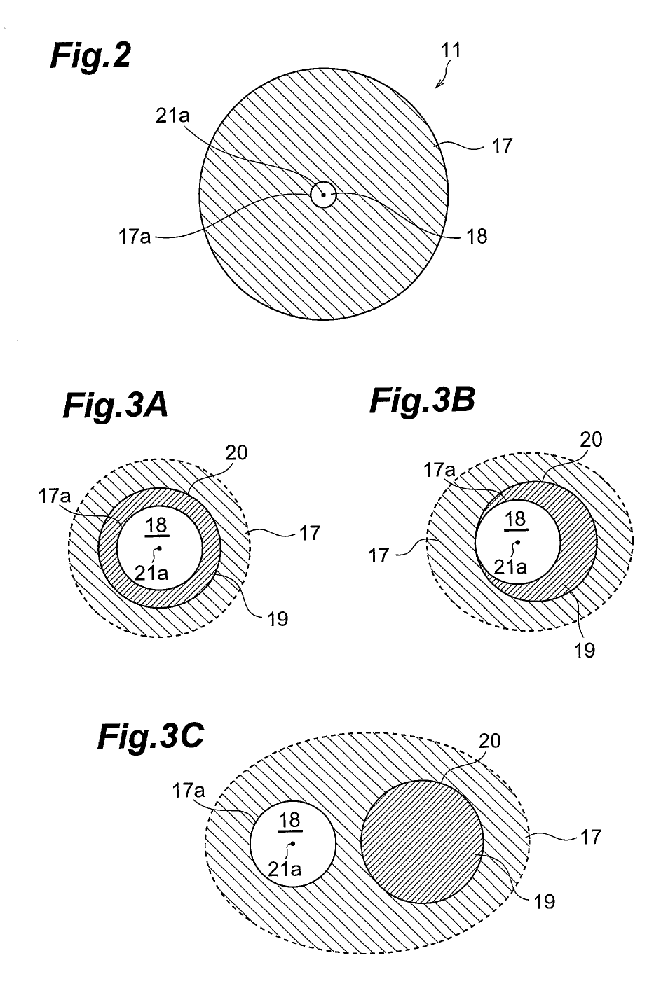

As shown in FIG. 2, the mark plate 11 is an aperture constituting member having a circular opening 18. The opening 18 functions as an aperture stop which is necessary in term of designing the electronic optical system. The size of opening 18 is determined beforehand according to the effective diameter of electron beam 20. The mark plate 11 is arranged such that the center of opening 18 aligns with the reference axis 21a.

The mark plate 11 is coated with a fluorescent material (light-emitting material) 17 on the surface on the side where the electron beam 20 is incident. The fluorescent material 17 is applied in a doughnut form, whose edge 17a on the inside (on the reference axis 21a side) matches the outer shape of opening 18. Since the positional relationship between the opening 18 and the reference axis 21a clear, the positional relationship between the edge 17a of fluorescent material 17 and the reference axis 21a is also clear. The fluorescent material 17 is a material which emits fluorescence in a visible region upon irradiation with the electron beam 20.

On the other hand, as shown in FIG. 1, the loupe 13 is arranged such that the opening 18 of mark plate 11 and its surroundings, i.e., the edge 17a of fluorescent material 17 and its surroundings, are positioned within the field of view thereof. The outer periphery of loupe 13 is provided with an electrically conductive coating. The viewing window (window portion) 15 is fitted in a hole penetrating through the lens barrel 21.

In thus configured electron beam apparatus 10, the vicinity of opening 18 (vicinity of the edge 17a of fluorescent material 17) in the mark plate 11 can visually be observed under magnification by way of the viewing window 15 and loupe 13.

When the fluorescent material 17 of mark plate 11 is irradiated with the electron beam 20, the fluorescent material 17 at the irradiated part actually emits light. Consequently, if the part actually having emitted light is visually observed, then the fact that the electron beam 20 has reached the mark plate 11 can be verified.

As shown in FIGS. 3A to 3C, the light-emitting part 19 in the fluorescent material 17 has such size and form as to become a ring, a crescent, and a circle according to the size and form of the cross section of electron beam 20, and the positional relationship between the electron beam 20 and the edge 17a of fluorescent material 17. FIGS. 3A to 3C exemplify cases where the electron beam 20 has a circular cross section and is greater than the edge 17a (opening 18). Here, the light-emitting part 19 is formed like a ring as shown in FIG. 3A when there is no deviation in the positional relationship between the electron beam 20 and edge 17a.

Thus, if the form and size of the light-emitting part 19 of fluorescent material 17 are visually observed in the electron beam apparatus 10, then the size and form of cross section of electron beam 20, and the positional relationship between the electron beam 20 and edge 17a can be seen. Here, since the positional relationship between the edge 17a and reference axis 21a is clear as mentioned above, the positional relationship between the edge 17a and electron beam 20 represents the amount and direction of axial offset of electron beam 20 with respect to the reference axis 21a.

Similarly, by way of the other viewing window 16 and loupe 14 (FIG. 1), the vicinity of opening 18 (vicinity of the edge 17a of fluorescent material 17) in the other mark plate 12 can visually be observed under magnification in the electron beam apparatus 10. If the light-emitting part of the fluorescent material 17 applied to the mark plate 12 is visually observed, then the fact that the electron beam 20 has reached the mark plate 12 can be verified. Also, if the form and size of the light-emitting part of the fluorescent material 17 applied to the mark plate 12 are visually observed, then the size and form of the cross section of electron beam 20 at the position of mark plate 12 and the amount and direction of axial offset of electron beam 20 can be seen.

Further, since the mark plates 11, 12 are arranged at two positions, respectively, along the reference axis 21a, the amount and direction of axial offset of electron beam 20 at each position can be seen, whereby the angular deviation of electron beam 20 with respect to the reference axis 21a can be obtained.

As a result of the foregoing viewing, when the electron beam 20 is generating axial offset, a deflector (not depicted) of an adjusting device arranged upstream the electron beam apparatus 10 can be operated so as to deflect the path of electron beam 20, thereby adjusting the axial offset (positional deviation and angular deviation) of electron beam 20. Upon this adjustment, the axis of electron beam 20 aligns with the reference axis 21a (optical axis of electron lens 22), whereby axial alignment is attained.

Also, an electron lens or stigmeter (not depicted) of the adjusting device arranged upstream the electron beam apparatus 10 can be operated, so as to adjust the cross section of electron beam 20 to desirable size and form.

Second Embodiment

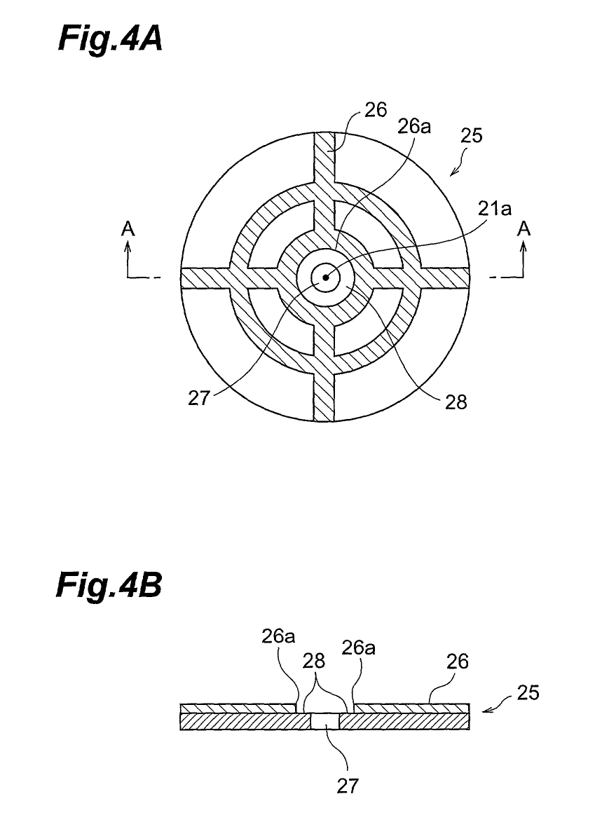

In the electron beam apparatus in accordance with a second embodiment, a mark plate 25 (FIGS. 4A and 4B), which will be explained later, is provided in place of the mark plate 11 constituting the electron beam apparatus 10 (FIG. 1) in the above-mentioned first embodiment. Since the electron beam apparatus in accordance with the second embodiment has the same configuration as that of the electron beam apparatus 10 except for the mark plate 25, the configuration other than the mark plate 25 will be neither depicted nor explained.

As shown in FIGS. 4A and 4B, the mark plate 25 in accordance with the second embodiment is an aperture constituting member formed with a circular opening 27. The opening 27 functions as an aperture stop which is necessary in term of designing the electronic optical system. The size of opening 27 is determined beforehand according to the effective diameter of electron beam 20.

In the mark plate 25, the area excluding a (ring-shaped) periphery 28 of the opening 27 is coated with a fluorescent material 26 in a scale form. Specifically, the fluorescent material 26 is applied in a form combining a cross pattern and a concentric circular pattern. Since each pattern has a known size, the cross pattern portion and concentric circular pattern portion of the fluorescent material 26 function as scales indicating the direction and the distance from the reference axis 21a, respectively.

The mark plate 25 is also arranged such that the center of opening 27 aligns with the reference axis 2la. Therefore, the positional relationship between each pattern of the fluorescent material 26 formed like a scale and the reference axis 21a is clear.

The fluorescent material 26 is a material which emits fluorescence in a visible region upon irradiation with the electron beam 20. The method of applying the fluorescent material 26 in a scale form to the mark plate 15 may comprise the step of masking the mark plate 25 into a desirable form or the steps of coating the whole surface with the fluorescent material and then covering the fluorescent material with a metal material into a desirable form.

In thus configured electron beam apparatus of the second embodiment, the scale-like fluorescent material 26 of mark plate 25 can visually be inspected under magnification by way of the viewing window 15 and loupe 13 (see FIG. 1).

If the form and size of light-emitting part of fluorescent material 26 are visually observed, so as to read out the scale according to the cross pattern and concentric circular pattern, then the size and form of cross section of electron beam 20 and the amount and direction of axial offset of electron beam 20 can be detected accurately.

Therefore, axial offset and cross-sectional states of electron beam 20 can be adjusted accurately by use of an adjusting device (deflector, electron lens, stigmeter, or the like) arranged upstream the electron beam apparatus.

If the cross section of electron beam 20 is adjusted so as to become smaller than the edge 26a on the inside (reference axis 21a side) of fluorescent material 26 upon the above-mentioned adjustment, then the fluorescent material 26 can be prevented from deteriorating upon irradiation with the electron beam 20 for a long period of time. Also, if the cross section of electron beam 20 is adjusted so as to become greater than the opening 27 of mark plate 25, then the function of the opening 27 as an aperture stop can be maintained.

Though the above-mentioned electron beam apparatus in accordance with the second embodiment relates to the fluorescent material 26 in a form combining a cross pattern and a concentric circular pattern, the pattern of fluorescent material applied to the mark plate is not restricted thereto. Patterns can be applied with intervals and forms corresponding to required scale functions. For example, the cross pattern or concentric circular pattern may be formed alone. Also, combinations with grid or stripe patterns, a grid pattern alone, a stripe pattern alone, and the like may be applied.

Third Embodiment

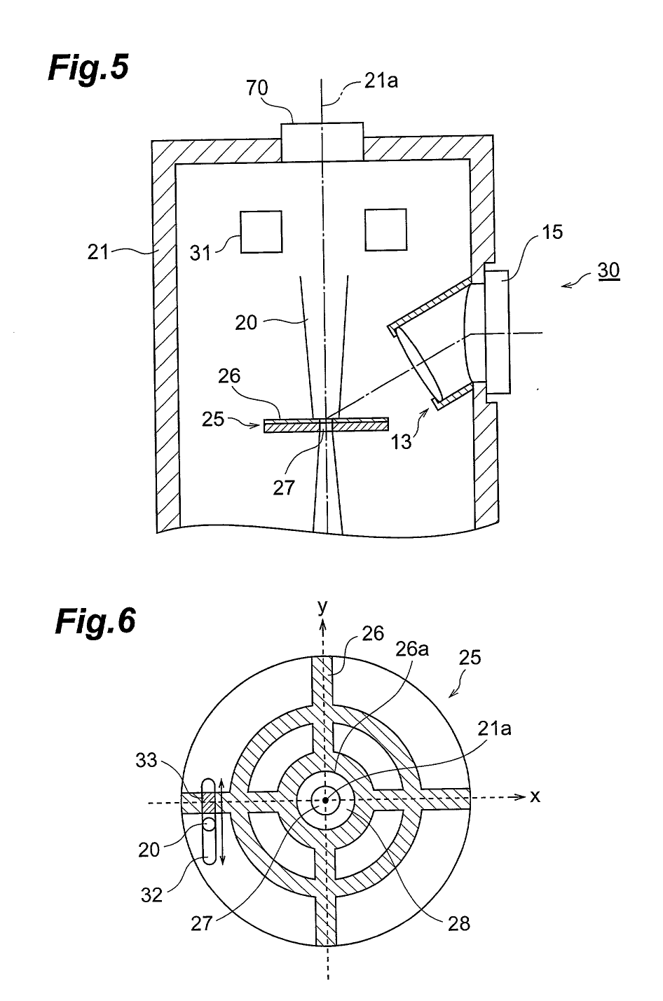

As shown in FIG. 5, an electron beam apparatus 30 in accordance with a third embodiment has a configuration in which a deflector 31 is arranged upstream the mark plate 25 (FIGS. 4A and 4B) constituting the electron beam apparatus of the above-mentioned second embodiment. Except for the deflector 31, the electron beam apparatus 30 has the same configuration as the electron beam apparatus in accordance with the second embodiment. In the mark plate 25 in the third embodiment, however, the opening 27 is assumed to function as a maintenance stop which is unnecessary in terms of designing an electronic optical system.

The deflector 31 of electron beam apparatus 30 is a control device for deflecting and controlling the path of electron beam 20. In response to the control signal given to the deflector 31, it can shift the path of electron beam 20 by a predetermined amount or scan the electron beam 20 one-dimensionally or two-dimensionally within a predetermined range at a high speed.

In the mark plate 25 of electron beam apparatus 30, the size of opening 27 is set greater than the effective diameter of electron beam 20 determined according to the design of electronic optical system.

In thus configured electron beam apparatus 30, the cross section of electron beam 20 is usually smaller than the opening 27 of mark plate 25, whereby the light-emitting part of fluorescent material 26 cannot always be visually observed. For example, when a part of the mark plate 25 other than the fluorescent material 26 is irradiated with the electron beam 20 having a small cross section as shown in FIG. 6, the fluorescent material 26 emits no light.

Therefore, the deflector 31 is used for controlling the electron beam 20, so as to carry out high-speed scanning in Y direction. Consequently, a linear area 32 elongated in Y direction of the mark plate 25 is irradiated with the electron beam 20. As a result, the electron beam 20 irradiates the fluorescent material 26 as well, whereby its light-emitting part 33 can visually be observed under magnification through the viewing window 15 and loupe 13.

Thus, the electron beam 20 is scanned at a high speed in the electron beam apparatus 30 of the third embodiment, whereby visibility can be improved in the case of the electron beam 20 having a small cross section as well. The range of high-speed scanning can be adjusted according to the pattern form of fluorescent material 26 and the irradiating position of electron beam 20.

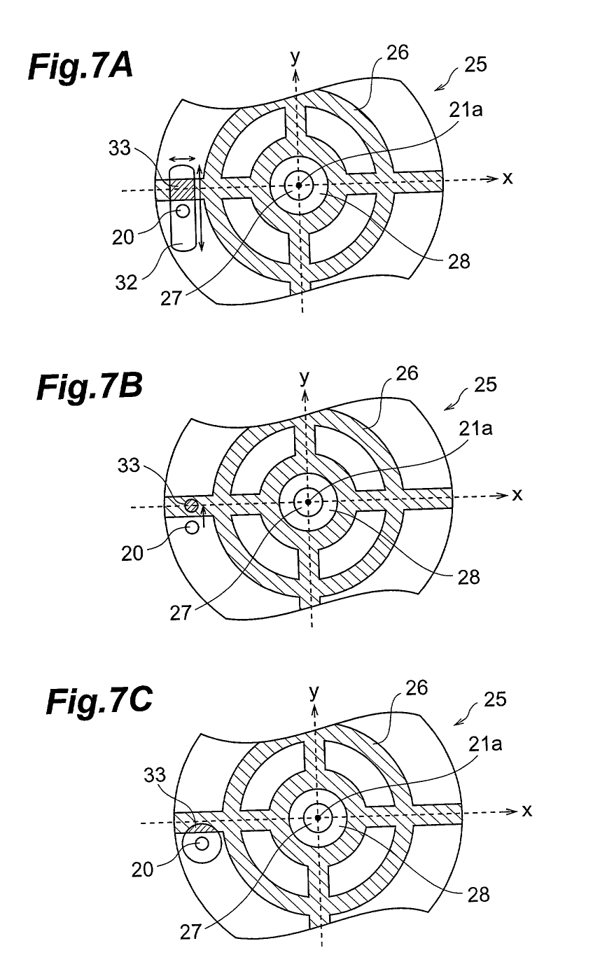

The high-speed scanning of electron beam 20 may be carried out not only in Y direction but also in X direction or oblique directions. Visibility can be improved not only when high-speed scanning is carried out linearly but also when it is carried out two-dimensionally (FIG. 7A). The electron beam 20 may also be shifted by a predetermined amount by use of the deflector 31 (FIG. 7B) instead of high-speed scanning.

Though the above-mentioned third embodiment relates to an example which improves visibility by controlling the path of electron beam 20 by use of the deflector 31, an electron lens (control device) for controlling the cross-sectional form of electron beam 20 may be provided in place of the deflector 31, so as to widen the cross section of electron beam 20, whereby visibility can be improved similarly (FIG. 7C). Here, a stigmeter (control device) may be used in place of the electron lens, so as to deform the cross section of electron beam 20.

Further, the path control of electron beam 20 by use of the deflector 31 and the cross section control of electron beam 20 by use of the electron lens or stigmeter may be combined together as appropriate.

While the above-mentioned third embodiment explains a case where the cross section of electron beam 20 is smaller than the opening 27 by way of example, it is also applicable to the case where the cross section of electron beam 20 is greater than the opening 27. For example, in the case where the cross section of electron beam 20 is so wide that the axial offset of electron beam 20 is hard to see, the cross section of electron beam 20 can be adjusted so as to become slightly greater than the opening of mark plate, whereby visibility can be improved.

Though the third embodiment relates to an example in which the opening 27 of mark plate 25 is a maintenance stop, it is also applicable to the case where the opening of mark plate is an aperture stop as in the above-mentioned first and second embodiments.

While the third embodiment explains an example in which the mark plate 25 is formed with the scale-like fluorescent material 26, it is also applicable to the mark plates 11, 12 in which the whole surface excluding the opening 27 is coated with the fluorescent material 17 as in the above-mentioned first embodiment. In this case, axial offset and cross-sectional states of the original electron beam 20 can be seen according to the edge positions on both ends of the light-emitting region obtained as results of the path control and cross section control of electron beam 20.

The control device (deflector 31, electron lens, or stigmeter) for controlling the path and cross section of electron beam 20 at the time of viewing mentioned above can also be used as an adjusting device used for axial offset adjustment and cross section adjustment after viewing.

Fourth Embodiment

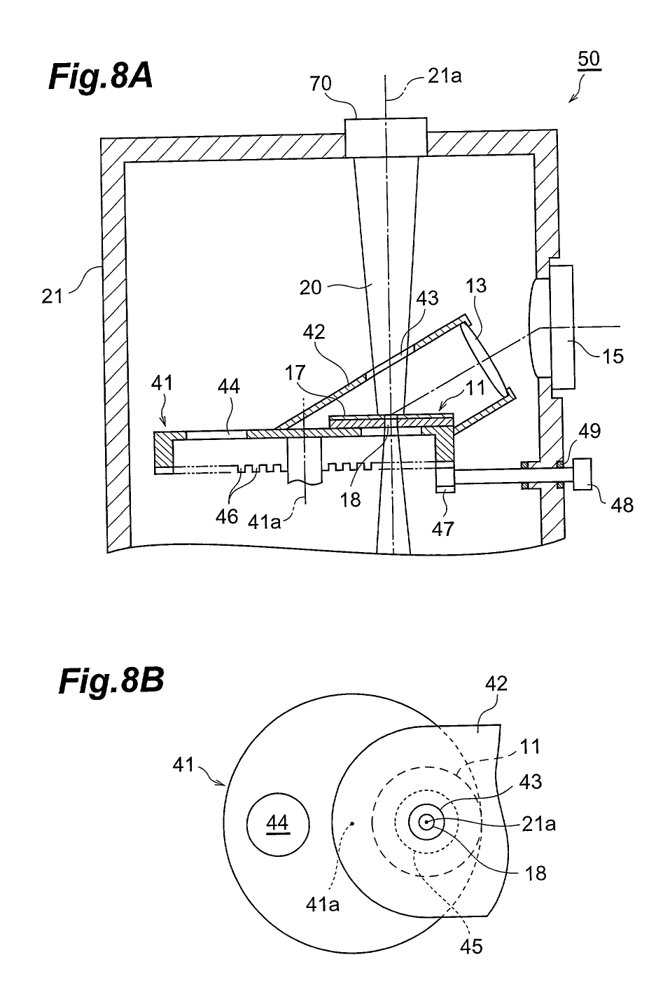

In an electron beam apparatus 40 in accordance with a fourth embodiment, a rotary table 41 is disposed within a lens barrel 21 for an electron beam 20 as shown in FIGS. 8A and 8B. The rotary table 41 of electron beam apparatus 40 is rotatable about an axis of rotation 41a which is parallel to a reference axis 21a. A mechanism for rotating the rotary table 41 is constituted by a gear 46 attached to the circumference of rotary table 41, a gear 47 in mesh with the gear 46, a shaft 48 which is secured to the gear 47 and extends to the outside of the lens barrel 21, and a vacuum seal 49 disposed between the shaft 48 and lens barrel 21. Also, a mechanism (not depicted) for positioning the rotary table 41 in the direction of angle of rotation is provided.

The rotary table 41 is provided with two openings 44, 45, whereas a mark plate 11 is attached thereto so as to cover one opening 45. In the mark plate 11, the opening 18 functions as a maintenance stop which is unnecessary in terms of designing an electronic optical system. The size of opening 18 of mark plate 11 is set so as to become smaller than the effective diameter of electron beam 20 determined by the design of electronic optical system.

Also, a loupe 13 is attached to the rotary table 41 by way of a holder 42 having a form covering the mark plate 11. The holder 42 is formed with a through hole 43 for passing the electron beam 20 therethrough.

The other opening 44 of rotary table 41 is formed at a position symmetrical to the above-mentioned opening 45 about the axis of rotation 41a, and functions as an aperture stop which is necessary in terms of designing the electronic optical system. The size of opening 44 is determined beforehand according to the effective diameter of electron beam 20. The opening 44 is greater than the opening 18 of mark plate 11.

Each of the distance between the center of opening 44 of rotary table 41 and the axis of rotation 41a, and the distance between the center of opening 18 of mark plate 11 and the axis of rotation 41a is equal to the distance between the axis of rotation 41a and reference axis 21a.

In thus configured electron beam apparatus 40, if the rotary table 41 is rotated about the axis of rotation 41a, then the mark plate 11 attached to the rotary table 41 and the opening 44 thereof can be moved across the path of electron beam 20 so as to be positioned alternately on the path of electron beam 20.

Therefore, when viewing axial offset and cross-sectional states of electron beam 20, the mark plate 11 is positioned on the path of electron beam 20, and the fluorescent material 17 of mark plate 11 is visually observed by way of the viewing window 15 and loupe 13. After the visual observation, the mark plate 11 is retracted, so that the opening 44 can be positioned in place thereof on the path of electron beam 20.

In the fourth embodiment, since the opening 44 is configured so as to become greater than the opening 18 of mark plate 11, the cross section of electron beam 20 can be narrowed even in its part having a larger effective diameter at the time of viewing the axial offset and cross-sectional states and adjustment after viewing, whereby highly accurate axial alignment is possible. In addition, after the adjustment, the cross section of electron beam 20 can be set to its original larger effective diameter.

Also, since the loupe 13 is retracted from near the path of electron beam 20 when unnecessary, a space for setting the effective diameter of electron beam 20 larger can be secured.

Further, since the mark plate 11 is retracted from the path of electron beam 20 when unnecessary, the fluorescent material 17 can be prevented from deteriorating upon irradiation with the electron beam 20 for a long period of time.

Though the above-mentioned fourth embodiment relates to an example in which the opening 44 is configured so as to become greater than the opening 18 of mark plate 11, the size of opening 44 may be set to the size of opening 18 of mark plate 11 or smaller depending on the effective diameter of electron beam 20.

While the above-mentioned fourth embodiment explains an example in which the mark plate 11 attached to the rotary table 41 is provided with the opening 18, the mark 11 may be made free of openings since it is retractable from the path of electron beam 20. In this case, similar viewing and adjustment can be carried out when all the area excluding the circular region having a size identical to that of the above-mentioned opening 18 is coated with a fluorescent material.

The mark plate attached to the rotary table 41 is not restricted to the mark plate 11 (FIG. 2) in which the whole surface excluding the opening 18 is coated with a fluorescent material, but may also be the mark plate 25 (FIG. 4) coated with a pattern of fluorescent material.

If the rotary table 41 is provided with a plurality of mark plates, then the cross section and axial offset of electron beam 20 can be viewed while the mark plates are exchanged as appropriate. In this case, if a plurality of mark plates are coated with different patterns of fluorescent material, then they can be used selectively depending on the state of electron beam 20.

Though the above-mentioned fourth embodiment explains the rotary table 41 by way of example, a linearly movable table may also be provided with mark plates, aperture stops, and the like.

Fifth Embodiment

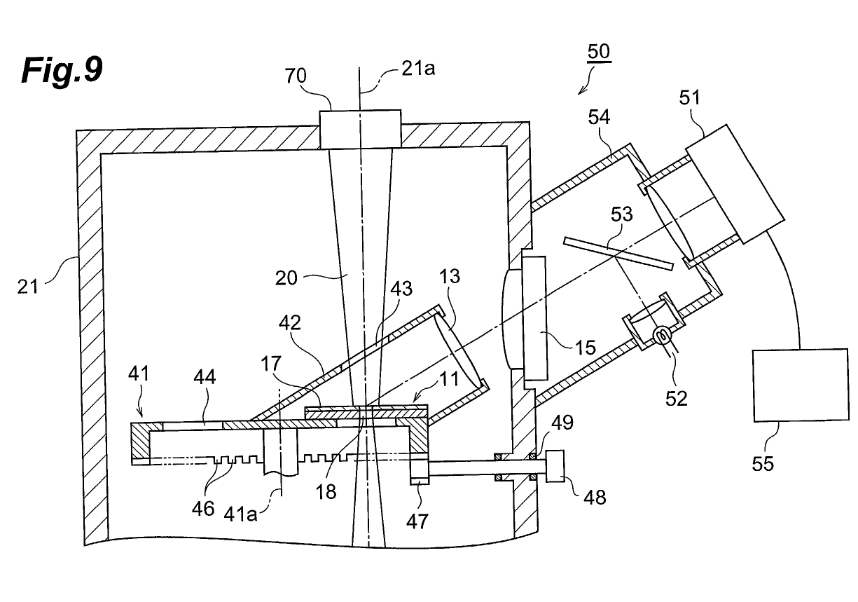

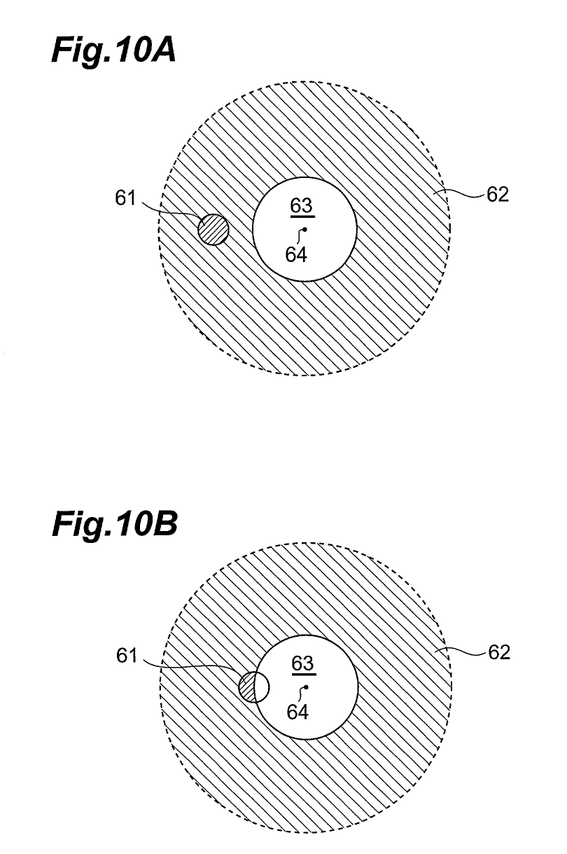

As shown in FIG. 9, an electron beam apparatus in accordance with a fifth embodiment has a configuration in which a CCD camera 51 and an illumination light source 52 (illuminating section) are further provided in addition to the above-mentioned electron beam apparatus 40 (FIG. 8).

In the electron beam apparatus 50, the CCD camera 51 and illumination light source 52 are disposed outside the lens barrel 21 and are held with a holder 54. Disposed inside the holder 54 is a half mirror 53 which reflects toward the viewing window 15 the luminous flux emitted from the illumination light source 52 and transmits therethrough the luminous flux from the viewing window 15 so as to guide it to the CCD camera 51. Also, a monitor 55 is connected to the CCD camera 51.

In thus configured electron beam apparatus 50, the luminous flux from the illumination light source 52 is introduced into the lens barrel 21 by way of the half mirror 53 and viewing window 15, and irradiates the vicinity of the opening 18 of mark plate 11 by way of the loupe 13. Since the mark plate 11 is illuminated with the luminous flux from the illumination light source 52 as such, axial offset and cross-sectional states of electron beam 20 can be viewed reliably even when the inside of lens barrel 21 is dark.

Also, since the CCD camera 51 is used as a viewing sensor, so as to view the image displayed on the monitor 55, it is unnecessary to directly look into the viewing window 15 by naked eye, whereby the axial offset and cross-sectional states of electron beam 20 can be viewed easily at any part of the apparatus.

In the above-mentioned fifth embodiment, since the CCD camera 51 is used as a viewing sensor, the axial offset and cross-sectional states of electron beam 20 can be adjusted automatically upon image processing if an image processing unit is connected to the CCD camera 51.

Though the fifth embodiment relates to an example in which the illumination light source 52 is provided so as to illuminate the mark plate 11, the illumination light source 52 may be omitted as in the above-mentioned first to fourth embodiment.

While both of the mark plate 11 and loupe 13 are attached to the rotary table 41 in the fourth and fifth embodiments, the loupe 13 may be attached to the lens barrel 21 as in the first and third embodiments.

Though each of the above-mentioned embodiments explains an example in which the lens barrel 21 is provided with a viewing window (15, 16), so that the electron beam 20 is viewed according to the luminous flux guided to the outside of lens barrel 21 by way of the viewing window, the present invention is also applicable to the case where the lens barrel 21 is free of the viewing window. In this case, a CCD camera similar to that in the fifth embodiment (together with an illumination light source if necessary) is provided within the lens barrel 21, so that the output from CCD camera is displayed on a monitor installed outside the lens barrel 21, whereby similar viewing is possible. Also, the CCD camera (and the illumination light source) can be attached to a rotary table similar to that of the fourth and fifth embodiment, so as to be retracted from near the path of electron beam 20 when unnecessary. When the CCD camera (as well as the illumination light source) is disposed within the lens barrel 21, however, measures against heat and outgassing are necessary.

While the first to fifth embodiments relate to examples of mark plate arranged across the reference axis 2la of lens barrel 21, a mark plate may be disposed at a position deviating from the reference axis 21a if the positional relationship between the fluorescent material applied to the mark plate and the reference axis 21a of lens barrel 21 is clear. In this case, it will be sufficient if the electron beam at the time of viewing is guided to the mark plate while being deflected by a predetermined amount and then is swung back by the predetermined amount after viewing.

Though two mark plates are arranged along the path of electron beam 20 in the above-mentioned embodiments, one mark plate may be arranged alone in the case where it will be sufficient if the positional deviation and cross-sectional state of electron beam 20 can be viewed.

While the above-mentioned first to fourth embodiments relate to observation optical systems constituted by viewing windows and loupes, an illumination light source similar to that of the fifth embodiment may be provided so as to illuminate mark plates. If a mark plate is illuminated with the illumination light source, then the dirt attached to the mark plate (contamination) can be viewed without disassembling the lens barrel 21, whereby the maintainability improves.

Though each of the above-mentioned embodiments explains an example in which an electron beam apparatus is assembled near an electron lens arranged within the lens barrel 21, the electron beam apparatus of the present invention can be disposed near a deflector as well.

While the above-mentioned embodiments relate to a case where a mark plate formed with an opening functioning as an aperture stop or maintenance stop is coated with a fluorescent material, a mark plate formed with an opening functioning as a field stop can also be coated with a fluorescent material.

Though each of the above-mentioned embodiments explains an example in which mark plates are coated with a fluorescent material, any material (e.g., gallium arsenide) can be used as long as it emits light upon irradiation with an electron beam.

While each of the above-mentioned embodiments relates to a case where the fluorescent material of mark plate is viewed by use of a loupe constituted by a single lens, an optical microscope constituted by an objective lens and an eyepiece can also be used in place of the loupe.

Though the above-mentioned embodiments explain an example in which the axial offset (angular deviation or positional deviation) of electron beam 20 is adjusted by use of a deflector, it may also be adjustable by a position adjusting mechanism or gun aligner of an electron gun.

The present invention is also applicable to charged particle beam apparatus for viewing axial offset or cross-sectional states of charged particle beams (ion beams and the like) other than the electron beam.

As explained in the foregoing, since the light emitted upon irradiation with a charged particle beam is viewed, the charged particle beam apparatus of the present invention can inspect axial offset and cross-sectional states of charged particle beam accurately and easily, thereby improving the maintainability of apparatus.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A charged particle beam apparatus comprising:
charged particle beam outputting means for outputting a charged particle beam;
a lens barrel through which said charged particle beam passes;
a mark member having a light-emitting material on a surface on a side irradiated with said charged particle beam, and an opening, said light-emitting material emitting light upon irradiation with said charged particle beam; and
viewing means for viewing said light-emitting material of said mark member;
wherein said mark member is arranged within said lens barrel such that a center of said opening and a reference axis of said lens barrel align with each other.

2. A charged particle beam apparatus according to claim 1, wherein said light-emitting material is applied to said mark member in a scale form.

3. A charged particle beam apparatus according to claim 1, wherein said light-emitting material is applied to a region of said mark member excluding a periphery of said opening formed therein.

4. A charged particle beam apparatus according to claim 1, further comprising moving and holding means for holding said mark member and moving said mark member across a path of said charged particle beam.

5. A charged particle beam apparatus according to claim 1, wherein a plurality of said mark members are arranged at a plurality of locations along said reference axis, respectively.

6. A charged particle beam apparatus according to claim 1, wherein said viewing means has a window portion provided in said lens barrel.

7. A charged particle beam apparatus according to claim 1, wherein said viewing means has an illuminating section for illuminating said mark member.

8. A charged particle beam apparatus according to claim 1, further comprising a rotary table, rotatable about a predetermined axis of rotation parallel to said reference axis, having an opening centered at said reference axis;
wherein said mark member is mounted on said rotary table such that an axis thereof positioned symmetrical to said reference axis about said axis of rotation and a center of said opening formed in said mark member align with each other.

9. A charged particle beam apparatus according to claim 1, further comprising a control device, arranged upstream said mark member, for controlling at least one of path and cross-sectional form of said charged particle beam.

10. A charged particle beam apparatus according to claim 1, wherein said reference axis is an optical axis of an electronic optical system arranged within said lens barrel.
